(19) United States
(12) Patent Application Publication
(10) Pub. No.: US 2011/0157564 A1
(43) Pub. Date: Jun. 30, 2011

(54) LIGHT SOURCE DEVICE AND PROJECTION DISPLAY APPARATUS INCLUDING THE SAME

(76) Inventor: Tadashi Takeuchi, Tokyo (JP)

(21) Appl. No.: 12/737,287

(22) PCT Filed: Jun. 30, 2008
(86) PCT No.: PCT/JP2008/061851

§ 371 Date: Dec. 27, 2010

(51) Int. Cl. G03B 21/28; F21V 13/02

(52) U.S. Cl. 353/98; 362/551

(57) ABSTRACT

A light source device (1) according to the present invention includes: a light source (2); a light tunnel (4) having a rectangular shape in a cross section orthogonal to a longitudinal direction, the light tunnel (4) including an optical path (4a) formed therein, light reflected by the light source (2) entering the optical path (4a); and an explosion-proof glass (3) arranged between the light source (2) and the light tunnel (4), the explosion-proof glass (3) transmitting a part of the reflected light to make the part of the light enter the light tunnel (4). The light tunnel (4) is arranged in such a manner that the long side of the rectangular shape, which is parallel to a Z-axis in a corresponding state in which respective optical axes of the light source (2), the explosion-proof glass (3) and the light tunnel (4) correspond to one another in the direction parallel to a Y-axis, is parallel to a Z1-axis resulting from rotation of the Z-axis by angle α with reference to the Y-axis. The explosion-proof glass (3) is arranged in such a manner that the explosion-proof glass (3) is been rotated from the corresponding state by angle β with reference to an inclined axis (3a) orthogonal to the Y-axis and parallel to an axis resulting from rotation of the Z1-axis by no less than 0° and no more than 45° with reference to the Y-axis, the inclined axis (3a) extending through the center of the surface on the light emitter (2) side of the explosion-proof glass (3).

### TECHNICAL FIELD

The present invention relates to a light source device and a projection display apparatus including the same.

### BACKGROUND ART

Among the projection display apparatuses that project an image onto, e.g., a screen, for example, there is one using a reflective display device such as a DMD (digital micro-mirror device) that converts light into an image according to image signals. In a projection display apparatus using a DMD, light supplied from a light source device to the DMD via, e.g., a lens and a mirror is converted by the DMD into an image according to image signals, and the image is then enlarged by a projection lens and projected onto, e.g., a screen.

FIG. 1 is a schematic diagram illustrating a light source, an explosion-proof glass and a light tunnel in a light source device related to an invention according to the present application. This light source device includes light source 102 that emits light, explosion-proof glass 103, which is an optical member that transmits light, and light tunnel 104 that homogenizes brightness of the light.

Light source 102, which is a discharge lamp, includes light-emitting tube 102c arranged on optical axis 102d of light source 102, light-emitting tube 102c including light emitter 102a, and reflective mirror 102b, which is an ellipsoidal mirror with its inner wall surface formed of a reflective member.

The inner wall surface of reflective mirror 102b is a spheroidal surface with its long axis on optical axis 102d, and light emitter 102a is arranged at one focal point on the spheroidal surface on the bottom side of reflective mirror 102b, and light emitted by light emitter 102a is reflected by the inner wall surface toward another focal point of the spheroidal surface.

Light tunnel 104 has an elongated quadrangular prism shape, and in light tunnel 104, optical path 104a extending in a longitudinal direction of light tunnel 104 and having a rectangular shape in a cross section orthogonal to the longitudinal direction of light tunnel 104 is formed. Light tunnel 104 is arranged so that optical axis 102d of light source 102 extends through an optical axis in the center of optical path 104a.

An inner wall surface of light tunnel 104 is formed of a reflective member, and light reflected by reflective mirror 102b and entering optical path 104a from incident end 104b is repeatedly reflected by the inner wall surface of light tunnel 104 in the course of passing through optical path 104a, thereby the brightness of the reflected light is homogenized, and then the light exits from exit end 104c.

Ordinarily, the brightness of the light exiting from exit end 104c of light tunnel 104 is not completely homogenized but is high in a center portion of the light with optical axis 102d as its center. Thus, light exiting from exit end 104c of light tunnel 104, upon being converted into an image and projected onto, e.g., a screen by a display device such as a DMD, is displayed as an image including a bright area in a center area thereof.

Between light source 102 and light tunnel 104, explosion-proof glass 103 prepared by forming glass into a plate shape is arranged so that an optical axis of explosion-proof glass 103 extends through optical axis 102d of light source 102. Here, a state in which the respective optical axes of light source 102, explosion-proof glass 103 and light tunnel 104 in light source device correspond to one another as described above is referred to as a corresponding state.

Light-emitting tube 102c of light source 102 infrequently bursts and pieces of glass forming light-emitting tube 102c sometimes fly around; however, even in such case, this light source device can prevent light tunnel 104 from being damaged by, e.g., the flown glass pieces, as a result of light source 102 and light tunnel 104 being separated by explosion-proof glass 103.

Furthermore, a surface of explosion-proof glass 103 is coated with a reflective material that reflects light other than visible light (for example, ultraviolet (UV) light and infrared (IR) light). Consequently, in light passing through explosion-proof glass 103 and entering optical path 104a of light tunnel 104, light other than visible light has been removed as a result of being reflected by explosion-proof glass 103. Accordingly, in a projection display apparatus including this light source device, the amount of light other than visible light entering is reduced, e.g., a DMD, enabling suppression of a temperature increase in, e.g., the DMD.

However, in this light source device, light other than visible light in reflected light emitted by light source 102 is reflected by explosion-proof glass 103 toward the light source 102 side as return light. The largest part of the return light enters light emitter 102a in light-emitting tube 102c, which may result in light-emitting tube 102c being damaged owing to a temperature increase, thereby reducing the life of light source 102. Therefore, the configuration illustrated in FIG. 2 may be conceived of.

FIG. 2 is a schematic diagram illustrating a light source, an explosion-proof glass and a light tunnel in a light source device in which a temperature increase in a light-emitting tube has been suppressed. In this light source device, explosion-proof glass 103 is arranged in a state in which optical axis 103b of explosion-proof glass 103 is rotated from the corresponding state relative to optical axis 102d of light source 102. Consequently, the focal position of the return light is shifted from the position of light emitter 102a arranged at the focal position of reflective mirror 102b, enabling suppression of a temperature increase in light-emitting tube 102c caused by the return light.

The angle of inclination of optical axis 103b of explosion-proof glass 103 relative to optical axis 102d of light source 102 is empirically determined while performing temperature measurement: an angle approximately in a range from 20° to 45° is often employed. In this light source device, the angle of inclination of optical axis 103b of explosion-proof glass 103 relative to optical axis 102d of light source 102 is 30°.

However, when explosion-proof glass 103 is arranged with optical axis 103b of explosion-proof glass 103 inclined relative to optical axis 102d of light source 102, the focal position of the light passing through explosion-proof glass 103 deviates from optical axis 102d of light source 102d and light tunnel 104 as a result of the light being refracted by explosion-proof glass 103.

Consequently, a part of the light passing through explosion-proof glass 103 sometimes runs off incident end 104b of light tunnel 104, not entering optical path 104a. In such a light source device, since the amount of light not entering optical path 104a of light tunnel 104 is larger, the brightness of an image projected by the projection display apparatus is lower.

In order to suppress a decrease in brightness of an image projected by a projection display apparatus, which is caused by the focal position of the light passing though explosion-proof glass 103 deviating from optical axis 102d of light source 102 and light tunnel 104, explosion-proof glass 103 can be arranged in such a manner that the angle of inclination of optical axis 103b of explosion-proof glass 103 relative to optical axis 102d of light source 102 is small. Consequently, although the effect of suppressing a temperature increase in light-emitting tube 102c is reduced, the temperature increase in light-emitting tube 102c can substantially be suppressed compared to the case where explosion-proof glass 103 is arranged with no inclination.

As a result of explosion-proof glass 103 being arranged in such a manner that the angle of inclination of optical axis 103b of explosion-proof glass 103 relative to optical axis 102d of light source 102 is small, the focal position of the light passing through explosion-proof glass 103 does not largely deviate from optical axis 102d. Consequently, even though explosion-proof glass 103 is arranged with optical axis 103b of explosion-proof glass 103 inclined relative to optical axis 102d of light source 102, a decrease in brightness of an image projected by the projection display apparatus is less likely to occur.

A projection display apparatus including an explosion-proof glass in which optical axis 103b of explosion-proof glass 103 is arranged with an inclination of a very small angle relative to optical axis 102d of light source 102 as described above is described in JP2007-265755A and JP2007-279764A.

However, the focal point of the light passing though explosion-proof glass 103 with optical axis 103b of explosion-proof glass 103 inclined relative to optical axis 102d of light source 102 slightly deviates from optical axis 102d even in the case where the angle of inclination of explosion-proof glass 103 is small. As a result of the focal position of the light that passes through explosion-proof glass 103 deviating from optical axis 102d, the bright portion of the light exiting from exit end 104c of light tunnel 104 is shifted from the center portion with optical axis 102d as its center.

Consequently, the light exiting from exit end 104c of light tunnel 104, upon being converted into an image and projected onto, for example, a screen by a display device such as a DMD, forms an image including a bright area at a position shifted from the center area.

In the case where a bright area in an image is positioned in an area horizontally shifted from the center area of the image, the horizontal symmetry in the brightness of an image is impaired, giving a feeling of strangeness to a viewer of the image. Thus, this case is more likely to have a visual impact on an image compared to the case where a bright area of an image is present in the center area of the image.

### SUMMARY

An object of the present invention is to provide a light source device capable of suppressing a temperature increase in a light-emitting tube without impairing the horizontal symmetry in the brightness of an image projected by a projection display apparatus, and a projection display apparatus including the light source device.

A light source device according to the present invention includes: a light source including a light-emitting tube including a light emitter that emits light, and a reflective mirror that reflects light emitted by the light emitter; a light-guiding member having a rectangular shape in a cross section orthogonal to a longitudinal direction, the light-guiding member including an optical path formed therein, the light reflected by the light source entering the optical path; and an optical member arranged between the light source and the light-guiding member, the optical member transmitting a part of the reflected light to make the part of the light enter the light-guiding member.

The light-guiding member is arranged in such a manner that the long side of the rectangular shape parallel to the Z-axis in a corresponding state in which respective optical axes of the light source, the optical member and the light-guiding member correspond to one another in the direction parallel to a Y-axis is parallel to the Z1-axis resulting from rotation of the Z-axis by a predetermined angle with reference to the Y-axis.

The optical member is arranged in such a manner that the optical member is rotated from the corresponding state by a predetermined angle with reference to an inclined axis orthogonal to the Y-axis and in parallel to an axis resulting from rotation of the Z1-axis by no less than 0° and no more than 45° with reference to the Y-axis, the incline axis extending through the center of the surface on the light emitter side of the optical member.

### BRIEF DESCRIPTION OF THE DRAWINGS

FIG. 1 is a schematic diagram of a light source device related to an invention according to the present application;

FIG. 2 is a schematic diagram of a light source device related to an invention according to the present application;

FIG. 3 is a perspective view of a projection display apparatus including a light source device according to a first exemplary embodiment;

FIG. 4 is a schematic diagram of a configuration included in a chassis of the projection display apparatus illustrated in FIG. 3;

FIG. 5 is a partial perspective view of the light source device illustrated in FIG. 4;

FIG. 6 is a schematic diagram of the light source device illustrated in FIG. 4;

FIG. 7 is a schematic diagram illustrating tracks of light passing though an explosion-proof glass in the light source device illustrated in FIG. 4;

FIG. 8 is a schematic diagram illustrating tracks of return light in the light source device illustrated in FIG. 4;

FIG. 9 is a diagram illustrating the amounts of return light on a surface along line A-A′ in FIG. 8 by contour lines;

FIG. 10 includes schematic diagrams of the light source unit of the light source device illustrated in FIG. 4, and the light source unit, which is a comparative example;

FIG. 11 is a partial perspective view of the light source device according to a second exemplary embodiment;

FIG. 12 is a schematic diagram of the light source device according to a second exemplary embodiment;

FIG. 13 is a partial perspective view of the light source device according to a third exemplary embodiment; and

FIG. 14 is a schematic diagram of the light source device according to a third exemplary embodiment.

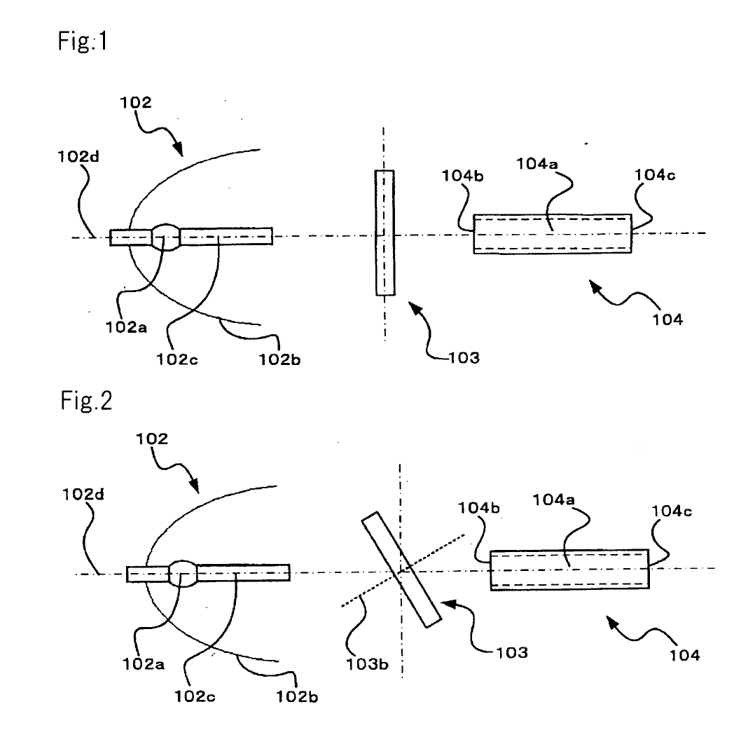

### DESCRIPTION OF EMBODIMENTS

Next, exemplary embodiments will be described with reference to the drawings.

### First Exemplary Embodiment

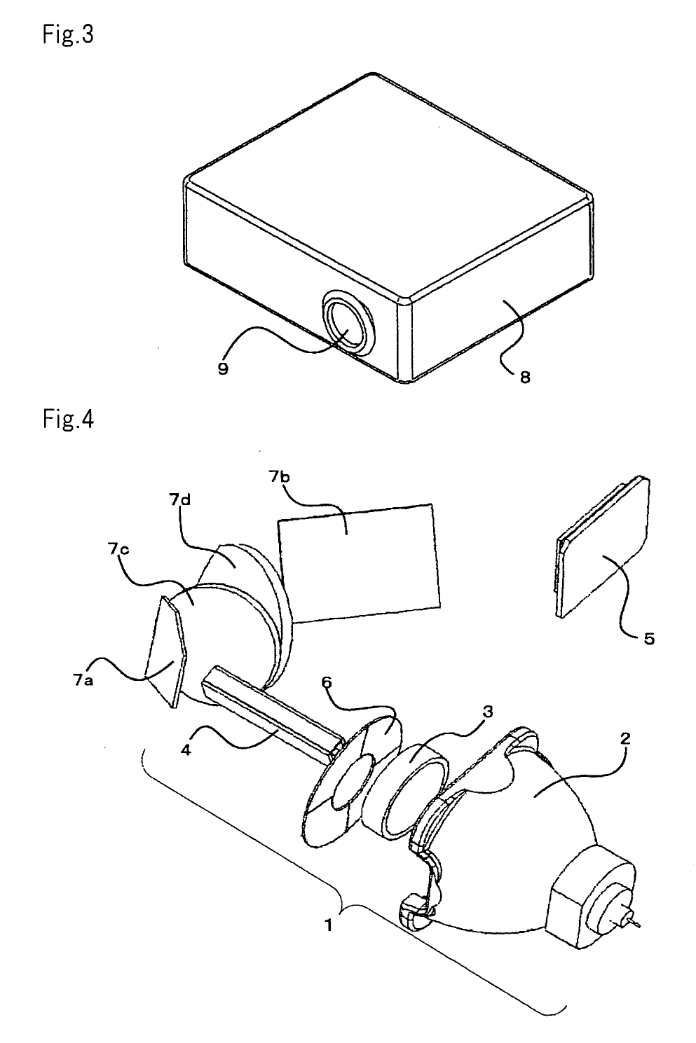

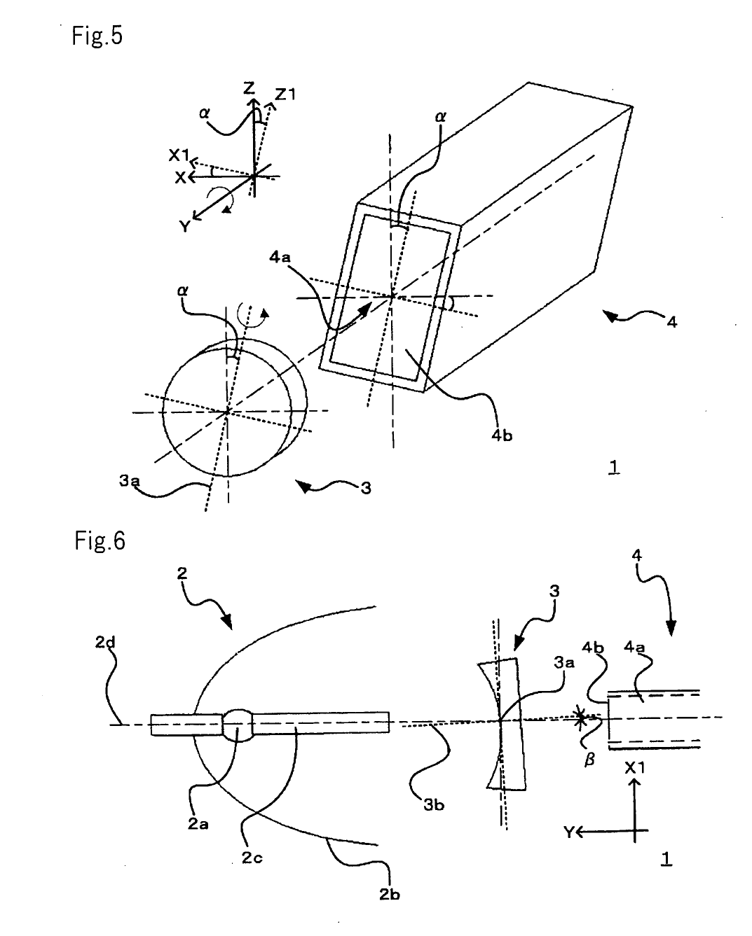

FIG. 3 is a perspective view of a projection display apparatus including a light source device according to a first exemplary embodiment. This projection display apparatus includes chassis 8 that houses, e.g., light source device 1 (see FIG. 4) according to the present exemplary embodiment therein, and projection lens 9 that enlarges and projects an image onto, for example, a screen.

FIG. 4 is a schematic diagram of a configuration housed in the chassis of the projection display apparatus illustrated in FIG. 3. This projection display apparatus includes light source device 1 that supplies light, DMD 5 that converts light into an image according to image signals, and mirrors 7a and 7b and lenses 7c and 7d that send light supplied from light source device 1 to DMD 5.

Light source device 1 includes light source 2 that emits light, explosion-proof glass 3, which is an optical member that transmits light, color wheel 6 that colors light, and light tunnel 4, which is a light-guiding member that homogenizes the brightness of light. Mirrors 7a and 7b and lenses 7c and 7d are arranged so that the exit end of light tunnel 4 in light source 2 and the reflective surface of DMD 5 have an optical conjugate relationship with each other.

In light source device 1, reflected light emitted by light source 2 passes through explosion-proof glass 3, and is then colored by color wheel 6, and then, the brightness of the reflected light is homogenized by light tunnel 4. In this projection display device, light supplied from light tunnel 4 in light source device 1 is sent to DMD 5 via first mirror 7a, first lens 7c, second lens 7d and second mirror 7b, converted into an image by DMD 5, and enlarged and projected onto, for example, a screen by projection lens 12 (see FIG. 3).

FIG. 5 is a perspective view illustrating the explosion-proof glass and the light tunnel in the light source device illustrated in FIG. 4. In this figure onwards, illustration of color wheel 6 is omitted for ease of description.

Light tunnel 4 has an elongated quadrangular prism shape, and in light tunnel 4, optical path 4a extending in the longitudinal direction of light tunnel 4 and having a rectangular shape in a cross section orthogonal to the longitudinal direction of light tunnel 4 is formed. The inner wall surface of light tunnel 4 is formed of a reflective member, and optical path 4a includes incident end 4b at an end on the explosion-proof glass 3 side. For such a light-guiding member, a known light-guiding member other than a light tunnel, such as a rod integrator, can be used.

Here, it is assumed that mutually-orthogonal axes parallel to the bottom surface of chassis 11 (see FIG. 3) of the projection display apparatus, which is a surface on which light source device 1 is installed, are an X-axis and a Y-axis, and an axis orthogonal to the bottom surface of chassis 11 is a Z-axis. The Y-axis is parallel to the longitudinal direction of light tunnel 4. It is also assumed that axes resulting from rotation of the X-axis and the Z-axis by angle α, which is a predetermined angle, with reference to the Y-axis are an X1-axis and a Z1-axis, respectively.

Furthermore, the state in which respective optical axes of light source 2, explosion-proof glass 3 and light tunnel 4 in light source device 1 correspond to one another in the direction parallel to the Y-axis, and the short side and the long side of the rectangular cross section of optical path 4a are parallel to the X-axis and the Z-axis, respectively, is referred to as a corresponding state.

Light tunnel 4 is arranged so that the short side and the long side of the rectangular shape of optical path 4a in the cross section orthogonal to the longitudinal direction of light tunnel 4 are parallel to the X1-axis and the Z1-axis, respectively. Accordingly, light tunnel 4 is arranged in such a manner that the long side of the rectangular cross section of optical path 4a has been rotated by angle α relative to Z-axis with reference to the Y-axis. The size of angle α is determined by the configuration of, for example, optical components mounted in the projection display apparatus: in light source device 1 according to the present exemplary embodiment, angle α is 30°.

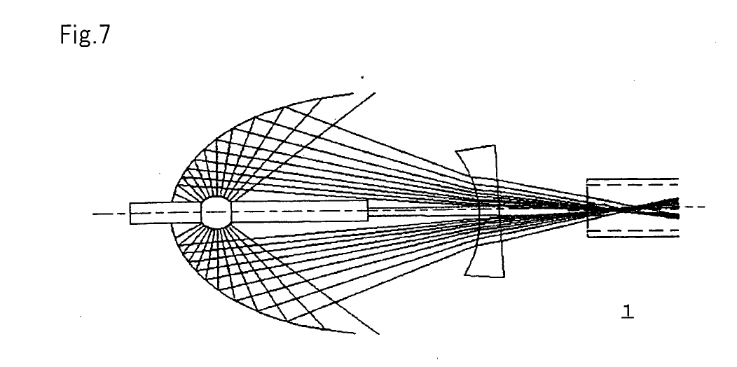

FIGS. 6 and 7 are schematic diagrams of the light source, the explosion-proof glass and the light tunnel in the light source device illustrated in FIG. 4, viewed in the direction of the Z1-axis in FIG. 5. Also, in FIG. 7, tracks of light passing through explosion-proof glass 3 are indicated by solid lines.

Light source 2, which is a discharge lamp, includes light-emitting tube 2c arranged on optical axis 2d of light source 2, the light-emitting tube 2c including light emitter 2a, and reflective mirror 2b, which is an ellipsoidal mirror with its inner wall surface formed of a reflective member. For example, reflective mirror 2b is formed so as to have an opening with a diameter of a little less than 60 mm, and a depth from the opening to the bottom of approximately 55 mm. Light tunnel 4 is arranged so that optical axis 2d extends through the optical axis, which is the center of optical path 4a.

Explosion-proof glass 3 is a plano-concave lens in which one surface on the light source 2 side is a concave surface while another surface on the light tunnel 4 side is a planar surface. For example, explosion-proof glass 3 is formed so as to have a diameter of 30 mm, a center portion thickness of 3.8 mm, and a concave surface curvature radius of 25 mm. Explosion-proof glass 3 is arranged in such a manner that explosion-proof glass 3 has been rotated from the corresponding state by angle β, which is a very small angle, with reference to inclined axis 3a parallel to the Z1-axis (i.e., with an inclination of 0° relative to the Z1-axis), inclined axis 3a extending through the center of the surface on the light source 2 side of explosion-proof glass 3. In light source device 1 according to the present exemplary embodiment, angle β is 3°.

As illustrated in FIG. 7, even though optical axis 3b of explosion-proof glass 3 is arranged with an inclination relative to optical axis 2d of light source 2, the focal position of light passing through explosion-proof glass 3 has almost no deviation from optical axis 2d because of the smallness of angle β.

In the configuration of the present exemplary embodiment, assuming that the distance between the edge of optical path 4a in light tunnel 4 in a direction perpendicular to X1-axis and optical axis 2d is 100%, the distance at incident end 4b between a center of the light beam passing through explosion-proof glass 3 and incident on incident end 4b of light tunnel 4, and optical axis 2d falls within a distance range of approximately 5% of that distance. Accordingly, light source device 1 is less likely to cause a decrease in the brightness of an image projected by the projection display apparatus.

The shape of optical path 4a in light tunnel 4 in a cross section orthogonal to the longitudinal direction of light tunnel 4 is similar to the shape of an image projected by the projection display apparatus: the horizontal direction of the image projected by the projection display apparatus corresponds to the long-side direction of the rectangular cross section of optical path 4a, and the vertical direction of the image corresponds to the short-side direction of the rectangular cross section of optical path 4a.

Accordingly, where the focal position of the light passing through explosion-proof glass 3 is shifted in the long-side direction of the rectangular cross section of optical path 4a in light tunnel 4 from optical axis 2d, the bright area in the image is horizontally shifted from the center area, and where the focal position is shifted in the short-side direction of the rectangular cross section of optical path 4a in light tunnel 4, the bright area in the image is vertically shifted from the center area.

Since explosion-proof glass 3 is arranged in such a manner that explosion-proof glass 3 has been rotated by angle β, which is a very small angle, with reference to inclined axis 3a parallel to the Z1-axis, inclined axis 3a extending through the center of the surface on the light source 2 side of explosion-proof glass 3, the focal position of the light passing through explosion-proof glass 3 slightly shifts from optical axis 2d in the X1-axis direction. Since the X1-axis direction is the short-side direction of the rectangular cross section of the optical path in light tunnel 4, the bright area in an image projected by the projection display apparatus including light source device 1 is slightly shifted in the vertical direction but is not shifted in the horizontal direction.

If the bright area in an image projected by a projection display apparatus is vertically shifted from the center area in the image, the vertical symmetry of the brightness of the image is impaired. However, the vertical symmetry of the brightness of the image is less likely to have a visual impact compared to the horizontal symmetry. Accordingly, even in the case where the bright area in an image projected by the projection display apparatus including light source device 1 according to the present exemplary embodiment is vertically shifted, only a small visual impact is given on the image.

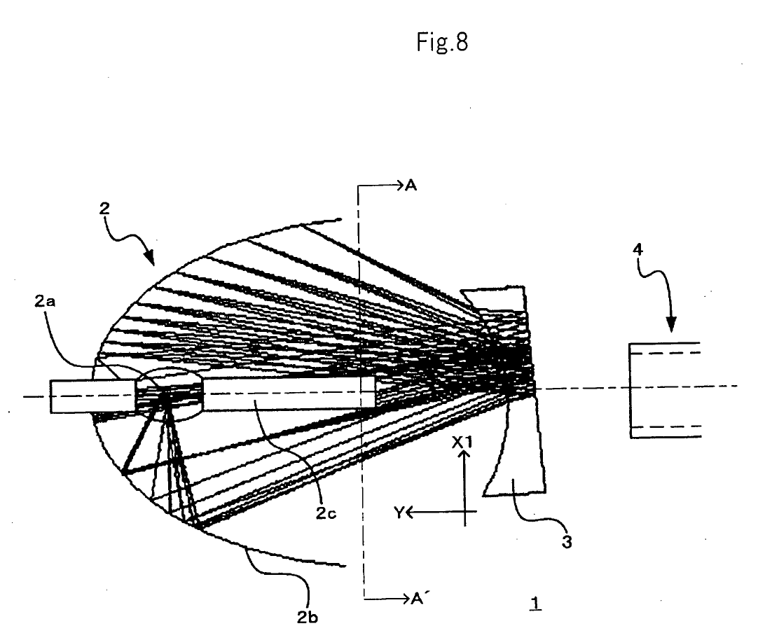

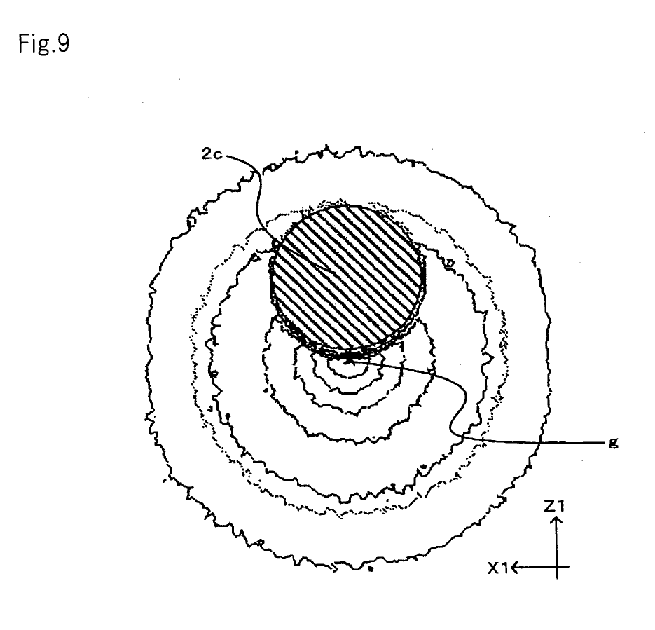

FIG. 8 is a schematic diagram of the light source, the explosion-proof glass and the light tunnel in the light source device illustrated in FIG. 4, viewed from the Z1-axis direction in FIG. 5.

The surface on the light tunnel 4 side of explosion-proof glass 3 is coated with a reflective material that reflects light other than visual light (for example, ultraviolet (UV) light and infrared (IR) light). Consequently, light, other than visible light, passing through explosion-proof glass 3 and entering optical path 4a in light tunnel 4 is reflected by the surface on the light tunnel 4 side of explosion-proof glass 3 as return light. Since the surface on the light tunnel 4 side of explosion-proof glass 3 is a planar surface, the surface can easily be coated with a reflective material.

FIG. 8 indicates a result of simulation of tracks of light emitted by light emitter 2a, reflected by reflective mirror 2b and then reflected by explosion-proof glass 3 toward the light source 2 side as return light, by solid lines. FIG. 8 indicates only light reflected by one half of reflective mirror 2b on the positive-direction side of the X1-axis.

Since the surface on the light source 2 side of explosion-proof glass 3 is a concave surface, the return light resulting from reflection by the surface on the light tunnel 4 side of explosion-proof glass 3 diffuses when the light exits from the concave surface. Consequently, tracks of return light from explosion-proof glass 3 change from tracks of light emitted by light emitter 2a and the enter explosion-proof glass 3, resulting in a decrease in the amount of return light entering light emitter 2a in light-emitting tube 2c.

FIG. 9 is a diagram indicating the result of simulation of the amount of return light on the surface along line A-A′ in FIG. 8 by contour lines. FIG. 9 provides a ten-level indication of the amount of return light assuming that the amount of return light at position g, which is a peak position having the largest amount of return light, is 100.

In the distribution of the amount of return light on the surface along line A-A′, it can be seen that the peak position g having a largest amount of return light lies off the area in which light-emitting tube 2c is arranged. This is an effect of arranging explosion-proof glass 3 with optical axis 3b of explosion-proof glass 3 inclined relative to optical axis 2d of light source 2.

In light source device 1 according to the present exemplary embodiment, although angle of the inclination of optical axis 3b of explosion-proof glass 3 relative to optical axis 2d of light source 2 is small, it has been confirmed that a temperature increase in the light-emitting tube can be reduced by approximately 40 degrees compared to the case where explosion-proof glass 3, which a flat plate-like explosion-proof glass whose two surfaces are planar surfaces, is arranged with no inclination. This is an effect of using a plano-concave lens for explosion-proof glass 3 and arranging explosion-proof glass 3 with optical axis 3b of explosion-proof glass 3 inclined relative to optical axis 2d of light source 2.

While it is desirable that angle β of the inclination of optical axis 3b of explosion-proof glass 3 relative to optical axis 2d of light source 2 be around 3° as in the present exemplary embodiment, the result of tests conducted for various angles showed that the effect of reducing a temperature increase in the light-emitting tube can be provided where angle β is no less than 1°.

Also, where angle β is no more than 30°, only a brightness decrease to a degree where there was no visual impact occurred in the image projected by the projection display apparatus. Furthermore, where angle β is no more than 15°, no brightness decrease occurred in the image projected by the projection display apparatus.

Also, when several plano-concave lenses with different concave-surface curvature radiuses within the range from 20 to 60 mm are provided and used by incorporating each of the plano-concave lenses into light source device 1, the effect of reducing a temperature increase in the light-emitting tube was obtained in each case.

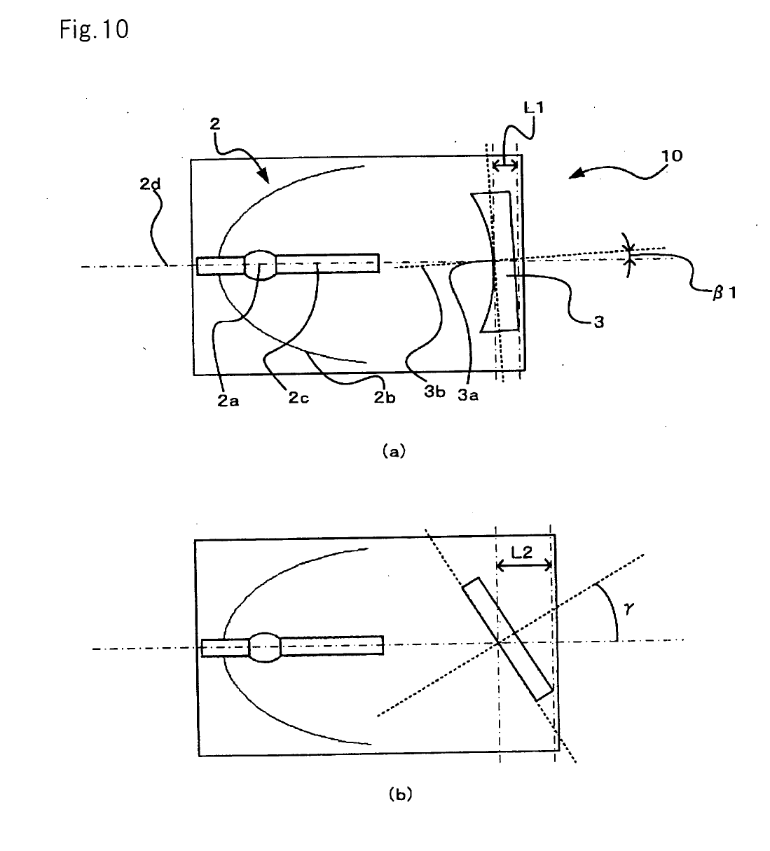

FIG. 10(a) is a schematic diagram illustrating a light source unit constituting a part of the light source device illustrated in FIG. 4. Light source unit 10 includes light source 2 and explosion-proof glass 3, and is attachable/detachable to/from chassis 8 (see FIG. 3) of the projection display apparatus including light source device 1.

Accordingly, if the projection display apparatus including light source device 1 cannot be used any longer because of end of the working life of, for example, light-emitting tube 2c in light source 2, the projection display apparatus can be easily repaired by exchanging light source units 10. Consequently, the ease of maintenance of the projection display apparatus including light source device 1 according to the present exemplary embodiment is enhanced.

FIG. 10(b) is a schematic diagram of a light source unit including a flat plate-like explosion-proof glass, two surfaces of which are planar surfaces, arranged with its optical axis inclined relative to an optical axis of a light source. The explosion-proof glass in this light source unit, which is formed so as to have a diameter of 30 mm and a thickness of 3.8 mm, is arranged with an inclination of 30° (angle γ). Distance L2 in the direction of the optical axis of the light source between a center of a surface on the light source side of the explosion-proof glass and an edge of the explosion-proof glass far from the light source in the light source unit is 11.8 mm.

Meanwhile, in light source unit 10 in light source device 1 according to the present exemplary embodiment, illustrated in FIG. 10(a), distance L1 in the optical axis 2d direction between the center of a surface on the light source 2 side of explosion-proof glass 3 and the edge of explosion-proof glass 3 far from light source 2 is 5.8 mm, which is approximately the half of distance L2 in the light source unit illustrated in FIG. 10(b). Accordingly, in light source device 1 according to the present exemplary embodiment, light source unit 10 can be downsized by reducing the length in the optical axis 2d direction of light source unit 10.

### Second Exemplary Embodiment

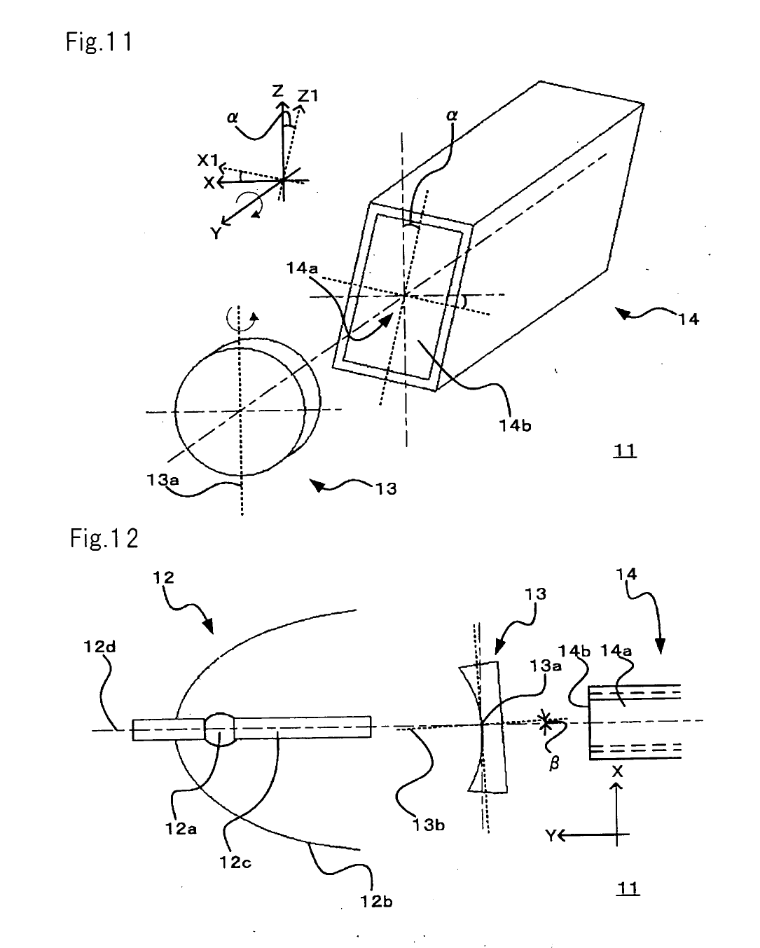

FIG. 11 is a perspective view illustrating explosion-proof glass and a light tunnel in a light source device according to a second exemplary embodiment of the present invention. Light source device 11 according to the present exemplary embodiment is configured so as to be similar to light source device 1 according to the first exemplary embodiment, except the below-described configuration.

FIG. 12 is a schematic diagram of a light source, the explosion-proof glass and the light tunnel in the light source device according to the present exemplary embodiment, viewed in the direction of a Z-axis in FIG. 11. Explosion-proof glass 13 is arranged in such a manner that explosion-proof glass 13 has been rotated by angle β, which is a very small angle, from a corresponding state with reference to inclined axis 13a parallel to the Z-axis, the inclined axis 13a extending through the center of a surface on the light source 12 side of explosion-proof glass 13.

In light source device 11, the focal position of light passing through explosion-proof glass 13 shifts from optical axis 12d in an X-axis direction. When the focal position of the light deviates from optical axis 12d in the X-axis direction, the focal point of the light is also moved in the Z1-axis, which is the long-side direction of the rectangular cross section of optical path 14a as well as an X1-axis direction, which is the short-side direction of the rectangular cross section of optical path 14a.

Where angle α is 45°, the distance of movement in the X1-axis direction of the focal point of the light and the distance of movement in the Z1-axis direction of the same are equal to each other, while where angle α is less than 45°, the distance of movement in the Z1-axis direction of the focal point of the light is smaller than the distance of movement in the X1-axis direction of the same.

In the present exemplary embodiment, angle α is 30°, i.e., less than 45°, and thus, the distance of movement of the focal point of the light from optical axis 12d in the Z1-axis direction, which is the long-side direction of the rectangular cross section of optical path 14a, is smaller than the distance of movement of the same in the X1-axis direction, which is the short-side direction of the rectangular cross section of optical path 14a.

Accordingly, the distance of a horizontal shift of a bright area of an image projected by a projection display apparatus including light source device 11 according to the present exemplary embodiment is relatively small compared to the distance of a vertical shift of the same. Consequently, light source device 11 according to the present exemplary embodiment also has a small visual impact on an image projected by the projection display apparatus.

Here, if angle α is no less than 0° and no more than 45°, the distance of the horizontal shift of the bright area of an image projected by the projection display apparatus is equal to or smaller than the distance of the vertical shift of the same, enabling reduction of the visual impact on the image projected by the projection display apparatus.

In light source device 11 according to the present exemplary embodiment, the focal position of the light passing through explosion-proof glass 13 slightly shifts from optical axis 12d also in the Z1-axis direction, which is the long-side direction of the rectangular cross section of optical path 14a, and thus, the horizontal symmetry in the brightness of an image projected by the projection display apparatus including the light source device according to the present exemplary embodiment is slightly impaired.

However, in light source device 11 according to the present exemplary embodiment, the disposition of explosion-proof glass 13 can be determined with reference to an axis perpendicular to the bottom surface of a chassis. The axis perpendicular to the bottom surface of the chassis is absolutely determined with reference to the bottom surface of the chassis, and thus, the disposition of explosion-proof glass 13 can be determined without depending on the disposition of light tunnel 14. Consequently, compared to the first exemplary embodiment requiring the disposition of an explosion-proof glass to be relatively determined with respect to a light tunnel, the design and manufacturing process are simplified, thereby providing an advantage in e.g., manufacturing cost reduction.

### Third Exemplary Embodiment

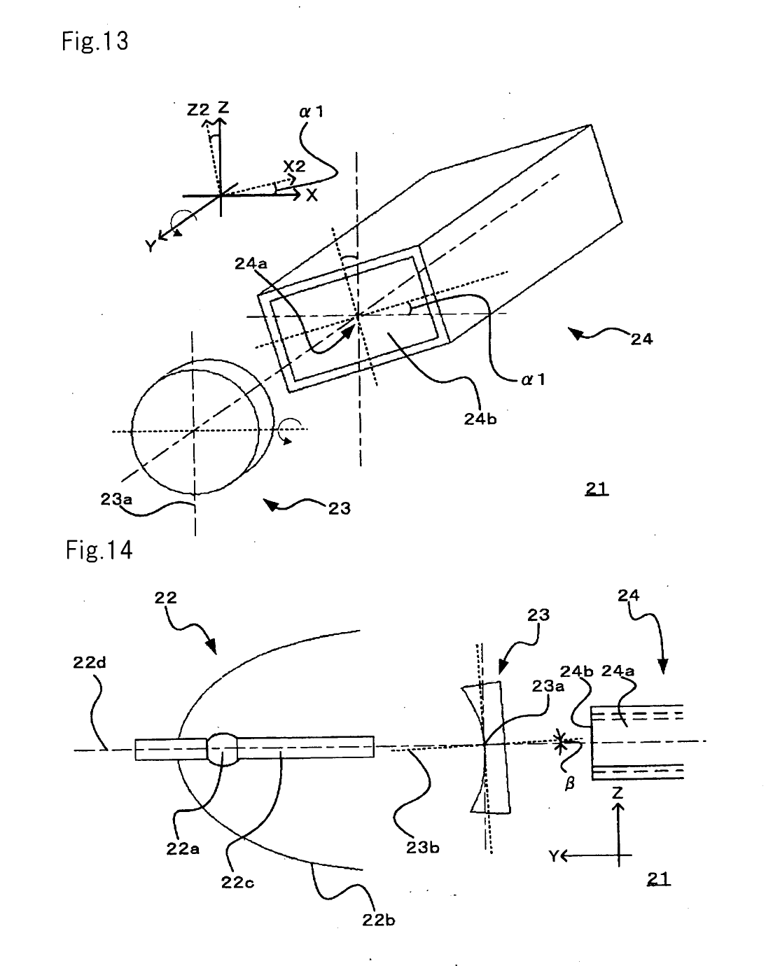

FIG. 13 is a perspective view illustrating an explosion-proof glass and a light tunnel in a light source device according to a third exemplary embodiment of the present invention. Light source device 21 according to present exemplary embodiment is configured so as to be similar to light source device 1 according to the first exemplary embodiment except the below-described configuration.

Here, it is assumed that axes resulting from rotation of an X-axis and a Z-axis by angle α1 with reference to a Y-axis are an X2-axis and a Z2-axis, respectively. Light tunnel 24 is arranged so that a short side and a long side of a rectangular cross section of optical path 24a are parallel to the Z2-axis and the X2-axis, respectively. In light source device 21 according to the present exemplary embodiment, angle α1 is 20°.

FIG. 14 is a schematic diagram of a light source, the explosion-proof glass and the light tunnel in the light source device according to the present exemplary embodiment, viewed in the X-axis direction in FIG. 13. Explosion-proof glass 23 is arranged in such a manner that explosion-proof glass 23 has been rotated by angle β, which is a very small angle, from a corresponding state with reference to inclined axis 23a parallel to the X-axis, inclined axis 23a extending through the center of the surface on the light source 22 side of explosion-proof glass 23.

In light source device 21, the focal position of light passing through explosion-proof glass 23 shifts from optical axis 22d in the Z-axis direction. When the focal position of the light shifts from optical axis 22d in the Z-axis direction, the focal point of the light is also moved in the X2-axis direction, which is the long-side direction of the rectangular cross section of optical path 24a as well as the Z2-axis direction, which is the short-side direction of the rectangular cross section of optical path 24a.

Where angle α1 is 45°, the distance of movement in the X2-axis direction of the focal point of the light and the distance of movement in the Z2-axis of the same are equal to each other, whereas where angle α1 is less than 45°, the distance of movement in the Z2-axis direction of, the focal point of the light is smaller than the distance of movement in the X2-axis direction of the same.

In the present exemplary embodiment, angle α1 is 20°, i.e., less than 45°, and thus, the distance of movement of the focal point of the light from optical axis 22d in the Z2-axis direction, which is the long-side direction of the rectangular cross section of optical path 24a, is smaller than the distance of movement of the same in the X2-axis direction, which is the short-side direction of the rectangular cross section of optical path 24a.

Accordingly, the distance of the shift in the horizontal direction of a bright area of an image projected by a projection display apparatus including light source device 21 according to the present exemplary embodiment is relatively smaller than the distance of the shift in the vertical direction of that. Consequently, light source device 21 according to the present exemplary embodiment also has a small visual impact on an image projected by the projection display apparatus.

Here, if angle α1 is no less than 0° and no more than 45°, the distance of the shift in the horizontal direction of a bright area of an image projected by the projection display apparatus is equal to or smaller than the distance of the shift in the vertical direction of that, thereby enabling reduction of a visual impact on an image projected by the projection display apparatus.

In light source device 21 according to the present exemplary embodiment, the focal position of the light passing through explosion-proof glass 23 slightly shifts from optical axis 22d also in the X2-axis direction, which is the long-side direction of the rectangular cross section of optical path 24a, and thus, the symmetry of the horizontal direction in brightness of an image projected by the projection display apparatus including the light source device according to the present exemplary embodiment is slightly impaired.

However, in light source device 21 according to the present exemplary embodiment, the disposition of explosion-proof glass 23 can be determined with reference to an axis perpendicular to a bottom surface of a chassis. The axis perpendicular to the bottom surface of the chassis is absolutely determined with reference to the bottom surface of the chassis, and thus, the disposition of explosion-proof glass 23 can be determined without depending on the disposition of light tunnel 24. Consequently, compared to the first exemplary embodiment requiring the disposition of an explosion-proof glass to be relatively determined to a light tunnel, the design and manufacturing process are simplified, providing an advantage in e.g., manufacturing cost reduction.

1. A light source device comprising:
a light source including a light-emitting tube including a light emitter that emits light, and a reflective mirror that reflects light emitted by the light emitter;
a light-guiding member having a rectangular shape in a cross section orthogonal to a longitudinal direction, the light-guiding member including an optical path formed therein, the light reflected by the light source entering the optical path; and
an optical member arranged between the light source and the light-guiding member, the optical member transmitting a part of the reflected light to make the part of the light enter the light-guiding member,
wherein the light-guiding member is arranged in such a manner that a long side of the rectangular shape, which is parallel to a Z-axis in a corresponding state in which respective optical axes of the light source, the optical member and the light-guiding member correspond to one another in parallel to a Y-axis, is parallel to a Z1-axis resulting from rotation of the Z-axis by a predetermined angle with reference to the Y-axis; and
wherein the optical member is arranged in such a manner that the optical member is rotated from the corresponding state by a predetermined angle with reference to an inclined axis orthogonal to the Y-axis and parallel to an axis resulting from rotation of the Z1-axis by no less than 0° and no more than 45° with reference to the Y-axis, the incline axis extending through a center of a surface on the light emitter side of the optical member.

2. The light source device according to claim 1, wherein the inclined axis is parallel to the Z1-axis.

3. The light source device according to claim 1, wherein the X-axis and the Y-axis are parallel to a surface on which the light source device is installed, and the inclined axis is parallel to the X-axis or the Z-axis.

4. The light source device according to claim 1, wherein the optical member is arranged in such a manner that the optical member is rotated by no less than 1° and no more than 30° with reference to the inclined axis.

5. The light source device according to claim 1, wherein the optical member includes a plano-concave lens including a concave surface formed on a surface on the light source side and a planar surface formed on another surface on the light-guiding member side.

6. The light source device according to claim 5, wherein the surface on the light-guiding member side of the optical member is provided with a coating having a reflective material that reflects light other than visible light.

7. The light source device according to claim 1, wherein the reflective mirror includes an ellipsoidal mirror.

8. The light source device according to claim 1, wherein the light-guiding member includes a light tunnel.

9. A projection display apparatus including the light source device according to claim 1.
